(19) United States
(12) Patent Application Publication
(10) Pub. No.: US 2005/0241899 A1
(43) Pub. Date: Nov. 3, 2005

(54) Vibration absorber for a pneumatically tired wheel

(76) Inventors: Rudiger Rutz, Kongen (DE); Peter Tattermusch, Esslingen (DE)

Correspondence Address: KLAUS J. BACH, 4407 TWIN OAKS DRIVE, MURRYSVILLE, PA, 15668, US

(21) Appl. No.: 11/133,168

(22) Filed: May 19, 2005

Related U.S. Application Data
(63) Continuation-in-part of application No. PCT/EP03/11867, filed on Oct. 25, 2003.

(30) Foreign Application Priority Data
Nov. 21, 2002 (DE) 102 54 344.5

(51) Int. Cl. F16F 7/10

(52) U.S. Cl. 188/381; 188/379

(57) ABSTRACT

In a vibration absorber for a pneumatic vehicle wheel having a brake with a brake disk and a brake caliper extending around the brake disk, at least part of the brake caliper forms a component of an oscillating vibration attenuating mass and is supported on a lever so as to permit movement thereof relative to the vehicle wheel.

This is a Continuation-in-Part Application of International Application PCT/EP2003/011867 filed Oct. 25, 2003 and claiming the priority of German application 102 54 344.5 filed Nov. 21, 2002.

### BACKGROUND OF THE INVENTION

The invention relates to a vibration absorber for a pneumatic vehicle wheel having a brake with a caliper extending around a brake disc.

To ensure a sufficient damping of wheel movements in vehicles, a certain minimum damper capacity of the conventional shock absorber is required. In vehicles with variable damping, this minimum damper capacity is adjusted for what is known as comfort mode. Any further increase in driving comfort, for example due to a lower damper capacity, would result in an insufficient damping of the wheel and consequently be detrimental to driving safety, for example because of what is known as wheel jumping. This can be counteracted by the use of suitably coordinated floatingly suspended additional masses on the wheel or on the wheel carrier. By means of the additional masses, such as vibration absorbers, the typical masses of which lie between 5 and 15 kg, the damper strength can be further reduced, without impairing the driving safety. However, because of the added weight, the unsprung masses of the wheel suspensions become increasingly higher, thus heightening a conflict of objectives in the design of springing and damping, particularly in connection with decreasing overall vehicle dimensions.

Vibration compensators and their operation are known per se. DE 100 34 603 A1 discloses such a system. This describes a chassis for a vehicle with pneumatically tired wheels, in which the wheel suspensions are supported individually relative to the vehicle body by means of spring/damper elements and in which additional vibration absorber masses mounted by means of independent spring/damper systems are provided in the region of the individual wheels.

DE 1 117 417 A1 discloses a dynamic oscillation damper. There, the brake caliper of a disk brake is articulated pivotably movably on the stub axle of a vehicle wheel and is mounted via springs oscillatably with respect to a lever supported on the vehicle body.

It is the object of the invention to improve the driving comfort, without the need for additional vibration attenuating masses.

### SUMMARY OF THE INVENTION

In a vibration absorber for a pneumatic vehicle wheel having a brake with a brake disk and a brake caliper extending around the brake disk, at least part of the brake caliper forms a component of an oscillating vibration attenuating mass and is supported on a lever so as to permit a certain movement thereof relative to the vehicle wheel.

Preferably, abutment means, which form spacers with respect to a stub axle by which the wheel is supported, are integrally formed with, or arranged on, the lever. As a result, the vibration attenuation effect is achieved, using a mass already present in the vehicle. Driving comfort is improved, without an increase in the overall weight. This has a beneficial effect on costs, fuel consumption and the consumption of resources. Furthermore, the unsprung masses of a vehicle which are to be damped are reduced, which has a beneficial effect on the vibration absorber action and consequently also on wheel damping and the comfort of the vehicle occupants.

It is beneficial, furthermore, that, in order to provide the attenuation mass, virtually no additional space is required on the wheel carrier. There is normally no useful construction space available there.

Further advantages and embodiments of the invention will become more readily apparent from the following description thereof on the basis of the accompanying drawing.

### BRIEF DESCRIPTION OF THE DRAWING

FIG. 1 shows a basic illustration of a preferred vibration absorber,

FIG. 2 shows a diagrammatic illustration of a preferred arrangement with two brake calipers,

FIG. 3 shows a preferred embodiment with two brake calipers and with a rubber bearing, and FIG. 4 shows a detail of a preferred embodiment with hydraulic damping.

### DESCRIPTION OF A PREFERRED EMBODIMENT

According to the invention, at least a part of a brake caliper of the brake is used as vibration compensator for a pneumatically tired wheel for counteracting oscillating vibration. In this case, one or more brake calipers of a wheel may be employed to counteract the wheel vibrations or oscillations. It is possible to use the entire brake caliper or only parts of it for that purpose, preferably a conventional protective frame or so-called floating frame of the brake caliper.

It is particularly beneficial that the weights of the components which are used according to the invention as vibration compensating mass lie in the range of typically 5 to 15 kg. This is a range which is actually effective for oscillation damping.

In the following figures, identical or identically acting elements are designated by the same reference symbols.

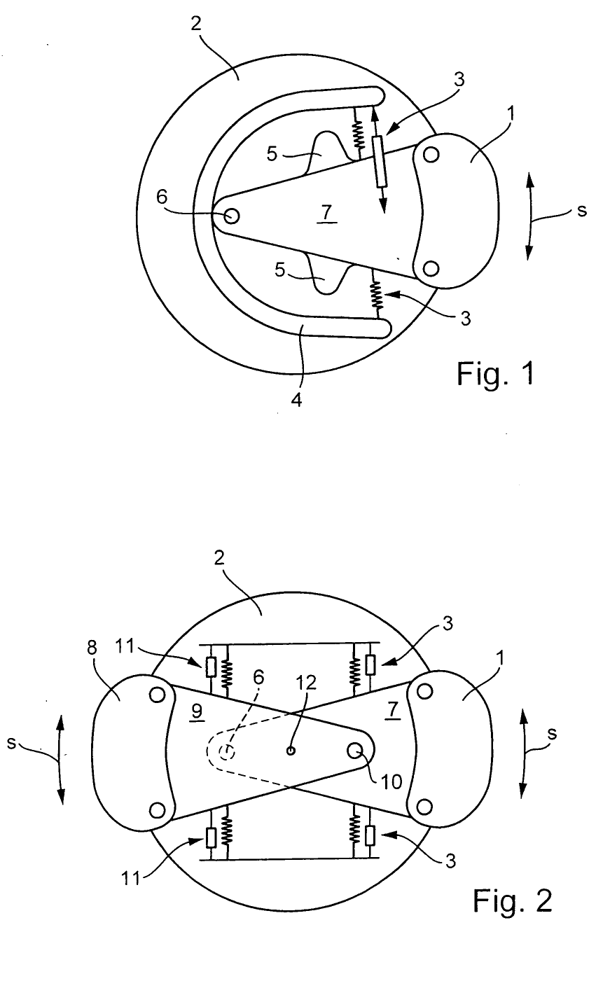

FIG. 1 as a basic illustration shows a preferred vibration absorber in a side view. A brake caliper 1 is arranged on a brake disk 2 and surrounds the latter in a known way. The brake caliper 1 is guided on a lever 7. The lever 7 points toward the stub axle 4, the lever 7 being mounted eccentrically rotatably on the stub axle 4 with respect to the wheel or the brake disk 2. For this purpose, the lever 7 is articulated on the stub axle 4 at an articulation point 6. The brake caliper 1 can thereby oscillate in a vertical direction, as indicated by the arrow S.

Expediently, the lever 7 may be formed by a brake stator.

The lever 7 is flat and is movable essentially parallel to the flat side of the brake disk 2.

In view of the effective weights of brake calipers between typically 5 kg and 15 kg, it is expedient, in addition to supporting the brake forces, to mount and damp the brake caliper 1 elastically. This is symbolized diagrammatically in the figure by components designated generally as spring/damper elements 3. A typical value for the amplitude of the brake caliper 1 is approximately ±10 to 25 mm.

Part of a stub axle 4, not illustrated in any more detail, is expediently designed in such a way that the space between limbs of the stub axle 4 is designed for receiving the oscillating brake caliper 1, for example in the form of a horseshoe. The articulation point 6 is then located at the vertex of the horseshoe-shaped stub axle 4. In this case, the lever 9 has integrally formed and/or arranged on it abutment means 5 which form a spacer with respect to the limbs of the stub axle 4. Abutment expediently takes place as gently as possible.

It is advantageous to set the damper force as a function of the speed of the brake caliper 1 or of the vibration absorber mass. This may take place, for example, by a characteristic curve which is filed in a control apparatus and by means of which the damping of the spring/damper elements 3 is set. It is beneficial to set hard damping until shortly before the abutment means 5 impinges on the stub axle 4.

FIG. 2 illustrates a preferred embodiment in which a plurality of brake calipers are coupled to one another. A symmetrical arrangement is beneficial particularly for a non-driven axle, in particular a front axle, while a one-sided arrangement, as in FIG. 1, is beneficial for a driven axle, in particular a rear axle.

A first brake caliper 1 is coupled via a coupling element 12 to a second brake caliper 8 preferably located diametrically opposite. In this case, a first lever 7 of the first brake caliper 1 is coupled to a second lever 9 of the second brake caliper 8 via the coupling element 12. The first lever 7 and the second lever 9 therefore overlap at least in regions. The first lever 7 is articulated by means of a bearing point 6 and the second lever 9 by means of a bearing point 10 on a stub axle, not illustrated. The coupling element 12 engages through both levers 7, 9.

The coupling imposes a joint lifting movement of the two brake calipers 1, 8. This ensures that both brake caliper masses always oscillate in synchronism, that is to say both are deflected upward or both are deflected downward. In the case of brake caliper masses of identical size, forces occur virtually only in the vertical direction. Springing and damping, here illustrated by the spring/damper elements 3 for the first brake caliper 1 and the spring/damper elements 11 for the second brake caliper 8, can take place between the two individual masses of the first and second brake calipers 1, 8 or between each individual mass of the first or the second brake caliper 1, 8 and the stub axle, not illustrated. This results in an assembly which is articulated on the stub axle solely at the two bearing points 6, 10 for the first and the second lever 7, 9 and is sprung and damped internally.

Preferably, the coupling element 12 is formed by a rubber bearing. A hydraulically damped rubber bearing is also beneficial.

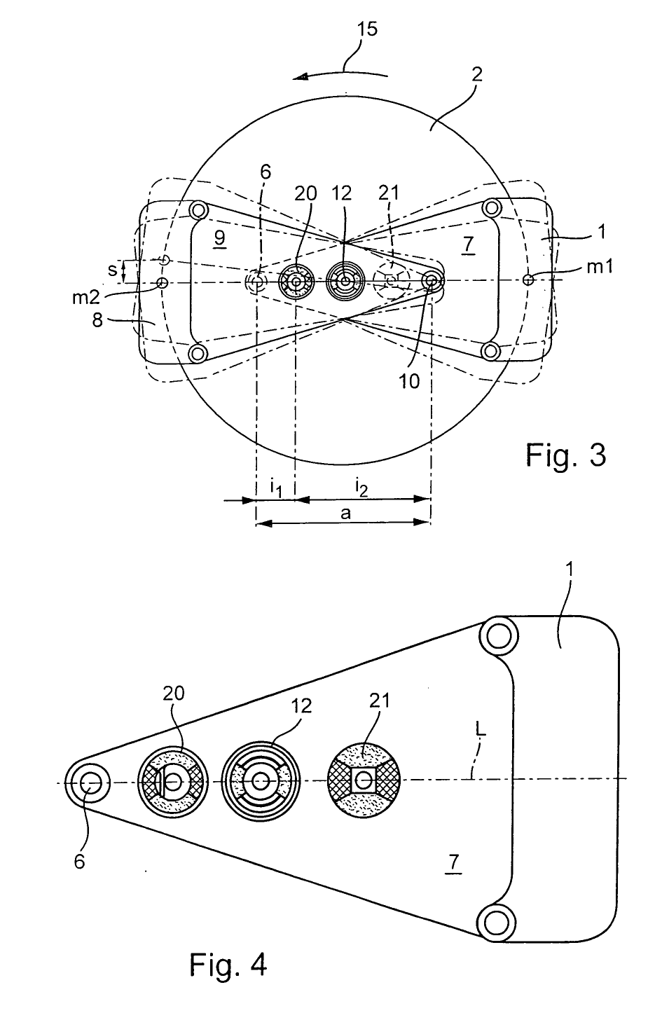

FIG. 3 illustrates a preferred embodiment of a coupling with a rubber bearing. The mass of the first brake caliper 1 is indicated by a mass point ml and the mass of the second brake caliper 8 is indicated by a mass point m2. The broken lines around the first and the second lever 7, 9 or brake caliper 1, 8 are intended to indicate the maximum deflection of the elements in the oscillating state. Typically, the brake caliper 1, 8 can be deflected by a few millimeters, particularly preferably by 10 to 25 mm, downward and/or up-ward.

When the wheel or the brake disk 2 rotates in the direction of the arrow 15, during braking the first brake caliper 1 is deflected in the direction of rotation. Without coupling, the second brake caliper would likewise be moved in the direction of the arrow 15. However, the coupling element 12, which is preferably designed as a hydraulically damped rubber bearing, blocks, so that the movement of the second brake caliper 8 in the direction of the arrow 15 is impeded. During the oscillation of the brake calipers 1, 8, the coupling element 12 is deformed, so that the two brake calipers 1, 8 oscillate synchronously and in phase. Springing and damping is then brought about by a spring/damper element 20 between the lever 7 of the first brake caliper 1 and the lever 9 of the second brake caliper 8. A further spring/damper element 21 may also be provided between the first and the second brake caliper 1, 8, so that a spring/damper element 20, 21 is arranged on both sides of the coupling element 12. The spring/damper elements 20, 21 are preferably designed as hydraulically damped rubber bearings. In this case, springing and/or damping takes place between the two levers 7, 9, but may also take place between the brake caliper 1, 8 or lever 7, 9 and stub axle.

The distance a between the two bearing points 6, 10 serves for designing the support for the braking torque. The spring excursion S_{F}, with

$${S}_{F} = ( \frac{1}{i1} - \frac{1}{i2} ) ,$$

serves for designing the spring excursion of the spring/damper element 20, 21.

A detail of the arrangement in FIG. 3 is emphasized in FIG. 4 for clarity. The brake caliper 1 is connected to a lever 7, preferably a brake stator. That end of the lever 7 which is opposite the brake caliper 1 has a bearing point 6, about which the lever 7 is pivotable and by means of which the lever 7 is articulated on a stub axle, not illustrated. A coupling element 12 is arranged on the bisecting line L of the arrangement between bearing point 6 and brake caliper 1. A spring/damper element 20 is provided on the bisecting line between the bearing point 6 and coupling element 12. Furthermore, a further spring/damper element 21 may be provided on the bisecting line L between the coupling element 12 and brake caliper 1. The coupling element 12 connects the arrangement to a second arrangement, not illustrated, according to the arrangement in FIG. 2 or FIG. 3. The coupling element 12 is designed as a hydraulic rubber bearing. When the brake caliper 1 is deflected in a vertical direction perpendicularly to the bisecting line, the coupling element blocks and prevents a deflection of the second brake caliper, not illustrated, in the same direction.

Springing and damping take place via the spring/damper element 20 between the first lever 7 and the lever, not illustrated, of the corresponding coupled device. In this case, softness and rigidity in a vertical and/or horizontal direction may be set by means of a suitable orientation and/or configuration of the spring/damper element 20, 21 with respect to the coupling element 12. In the figure, the coupling element 12 is rigid in the vertical direction, while the spring/damper element 20, 21 is designed to be soft in the vertical direction.

1. A vibration absorber for a pneumatic vehicle wheel having a brake with a brake disk (2),
+ a brake caliper (1) extending around the brake disk (2),
+ at least part of the brake caliper (1, 8) forming a component of an vibration attenuation arrangement,
+ the brake caliper (1, 8) being supported on a lever (7, 9), and
+ the lever (7, 9) being articulated on a stub axle (4) at a bearing point (6, 10), said lever (7) including abutment means (5) for engagement with limbs of the stub axle (4).

2. The vibration absorber as claimed in claim 1, wherein a protective frame of the brake caliper (1, 8) forms the vibration absorber mass.

3. The vibration absorber as claimed in claim 1, wherein the brake caliper (1, 8) is provided with a spring/damper element (3, 11, 20, 21).

4. The vibration absorber as claimed in claim 1, wherein the lever (7, 9) is formed by a brake stator.

5. The vibration absorber as claimed in claim 1, wherein the brake is mounted on the stub axle (4) and a part of the stub axle (4) on which the brake disk (2) is supported, has the form of a horseshoe, and the bearing point (6, 10) of the lever (7, 9) is provided at a vertex of the stub axle (4).

6. The vibration absorber as claimed in claim 1, wherein the stub axle (4) has the shape of limbs arranged with a space between the limbs of the stub axle (4) for receiving the oscillating brake caliper (1).

7. The vibration absorber as claimed in claim 1, wherein the brake caliper (1, 8) is supported so as to be movable in a plane parallel to the brake disk (2 ).

8. A vibration absorber for a pneumatic vehicle wheel having a brake with a brake disk (2),
+ the wheel having two brake caliper (1, 8) extending around the brake disk (2), and
+ at least part of each brake caliper (1, 8) forming a component of an oscillation vibration attenuation mass.

9. The vibration absorber as claimed in claim 8, wherein the two brake calipers (1, 8) are coupled to one another by means of a coupling element (12).

10. The vibration absorber as claimed in claim 9, wherein the coupling element (12) extends through the two levers (7, 9).

11. The vibration absorber as claimed in claim 9, wherein the coupling element (12) is a hydraulically damped bearing.

12. The vibration absorber as claimed in claim 8, wherein means (20, 21) for springing and damping are provided between the two brake calipers (1, 8).

13. The vibration absorber as claimed in claim 12, wherein the means (20, 21) provided for springing and damping between the first and the second brake caliper (1, 8) comprise a hydraulically damped rubber bearing.

14. The vibration absorber as claimed in claim 8, wherein the means (3, 11) for springing and damping are disposed between the brake calipers (1, 8) and a stub axle (4).

15. The vibration absorber as claimed in claim 8, wherein the brake calipers (1, 8) are arranged diametrically opposite one another on the brake disk (2).
